(19) United States
(12) Patent Application Publication
(10) Pub. No.: US 2024/0337137 A1
(43) Pub. Date: Oct. 10, 2024

(54) COMBINATION PADLOCK WITH INTEGRATED BOTTLE OPENER

(71) Applicant: HANDYWAY CO., LTD., CHANGHUA (TW)

(72) Inventor: Cheng-Yu TSAI, CHANGHUA (TW)

(21) Appl. No.: 18/545,363

(22) Filed: Dec. 19, 2023

(30) Foreign Application Priority Data
Apr. 7, 2023 (JP) 2023-001165

(51) Int. Cl. E05B 67/08; B67B 7/16

(52) U.S. Cl. CPC E05B 67/08; B67B 7/16

(57) ABSTRACT

A combination padlock with an integrated bottle opener comprising: a body featuring a shackle and two spaced apart side surfaces; wherein a central segment of the body extends and protrudes a tooth in the direction of the shackle; wherein the cross-sectional thickness of a free edge of the tooth is narrower than that of the body cross-section; and wherein the tooth extends and protrudes from only one of the side surfaces of the body.

### FIELD OF INVENTION

The present disclosure relates to the technical field of a combination padlock structure, in particular to a combination padlock with an integrated bottle opener.

### BACKGROUND OF THE INVENTION

Two common types of locks are key locks and combination locks. Key locks carry the inherent risk of key loss. Combination locks, on the other hand, offer a user-friendly alternative that requires the simple entry or rotation of a predetermined combination to unlock, making them a popular and accessible choice. Nevertheless, many combination locks on the market serve only as locks with no additional functionality, and given their robust structural design, combination locks can serve multiple purposes, including functioning as bottle openers, particularly for glass bottle caps.

### SUMMARY OF THE INVENTION

The purpose of the present disclosure is to introduce a combination padlock with an integrated bottle opener, comprising: a body featuring a shackle and two spaced apart side surfaces; wherein a central segment of the body extends and protrudes a tooth in the direction of the shackle; wherein the cross-sectional thickness of a free edge of the tooth is narrower than that of the body cross-section; and wherein the tooth extends and protrudes from only a single side surface of the body.

### BRIEF DESCRIPTION OF THE DRAWINGS

FIG. 1 is a three-dimensional view of an embodiment of the present disclosure.

FIG. 2 is a front view of an embodiment of the present disclosure.

FIG. 3 is a side view of an embodiment of the present disclosure.

### DETAILED DESCRIPTION OF THE PREFERRED EMBODIMENTS

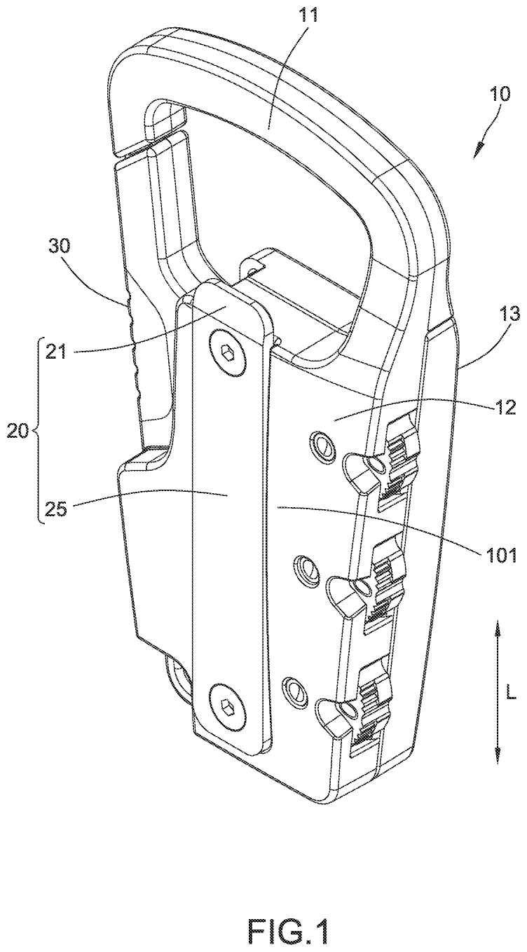

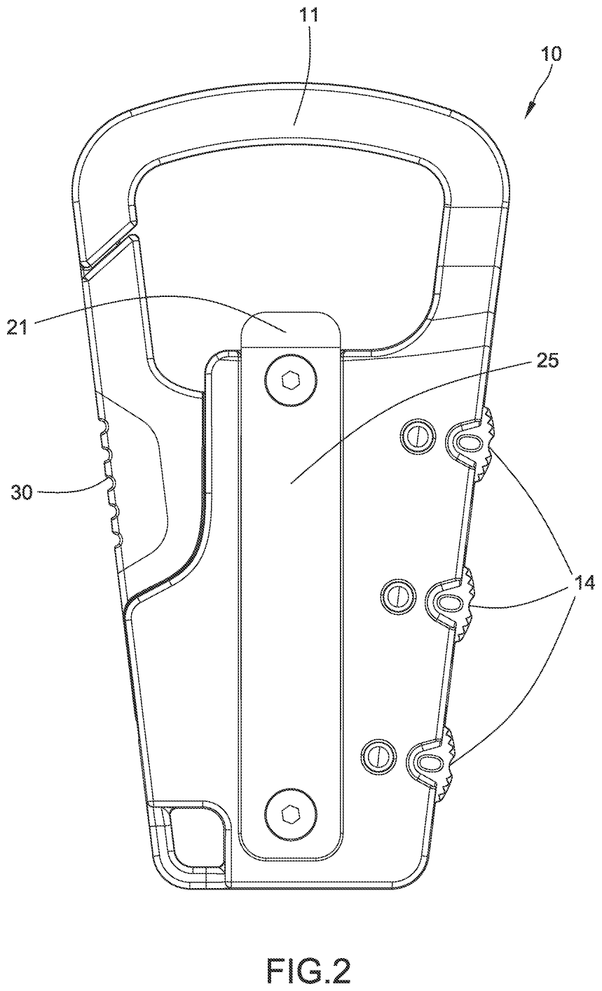

Referring to FIGS. 1 to 2, the drawings illustrate an embodiment of a combination padlock with an integrated bottle opener of the present disclosure. This device comprises a body 10 having a shackle 11 and two side surfaces 12, 13 spaced apart from each other.

A central segment 101 of the body 10 extends and protrudes a tooth 20 in the direction of the shackle 11. The cross-sectional thickness of the tooth 20 is narrower than that of the body 10 cross-section, and the tooth 20 extends and protrudes from only a single side surface 12 of the body 10.

The tooth 20 and the body 10 may be molded as a single integrated piece or may be assembled from two distinct elements. In this embodiment, the tooth 20 and the body 10 are two separate elements, with the tooth 20 is fixed with screw and embedded in a groove at one of the side surfaces 12 of the body 10.

The tooth 20 is in the form of a thin plate having a cross-sectional thickness that tapers from the central segment 101 of the body 10 toward the shackle 11. As a result, the cross-sectional thickness of the end of the tooth 20 (i.e., the free edge at the protruded portion 21) near the shackle 11 is narrower than that of the opposite end of the tooth 20 near the central segment 101 of the body 10.

in this embodiment, the tooth 20 extends from one end portion of the body in the longitudinal direction L to a boundary of the other end portion of the body in the longitudinal direction L, such segment 25 of tooth with uniform thickness is attached to the body, so as to maintain the structural strength in which is fixed to the body. The cross-sectional thickness in longitudinal direction L of the tooth tapers from a protruded portion 21 of the tooth at the boundary of the body toward the shackle.

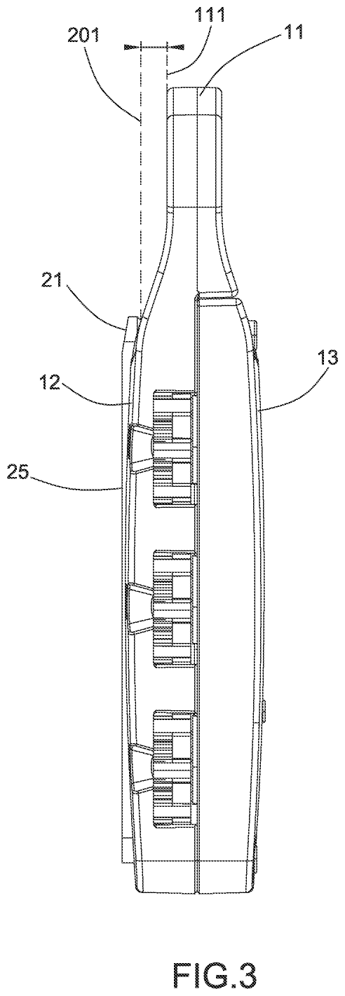

Moving to FIG. 3, the tooth 20 is embedded in one of the side surfaces 12 of the body 10, the thickness of the tooth 20 is thinner than the thickness of the shackle 11, and a virtual surface 111 extending from the surface of the shackle 11 is spaced apart from a virtual surface 201 extending from the surface of the tooth 20, creating a distance between the two virtual surfaces 111, and 201.

When using this device as a bottle opener, the user attaches the shackle 11 to the bottle cap with the tooth 20 against the bottom edge of the cap. This application results in an upward force that pries the cap using the principle of leverage.

In this embodiment, the body 10 further includes a release button 30 and multiple combination wheels 14 for combination setting and decoding within the combination padlock. When the combination padlock is in a locked state, the release button 30 remains stationary, allowing the shackle 11 to form a closed ring. In contrast, when the combination padlock is in an unlocked state, the release button 30 can be swung toward the inside of the shackle 11, creating an opening that is used to hook the shackle 11 to an object to be secured.

In light of the above, the present disclosure introduces a combination padlock structure with an integrated bottle opener function. This structure utilizes the combination padlock as a foundational element to create an integrated bottle opener element. As a result, the combination padlock not only performs its primary function of securing objects but also effectively utilizes the inherent strength of its own structure as an effective bottle opener tool. Consequently, the user only needs to carry a single tool that can fulfill at least two distinct functions.

What is claimed is:

1. A combination padlock with an integrated bottle opener, comprising:
a body having a shackle and two side surfaces spaced apart from each other;
wherein, a central segment of the body extends and protrudes a tooth in the direction of the shackle;
wherein, a cross-sectional thickness of a free edge of the tooth is narrower than that of the body cross-section; and
wherein, the tooth extends and protrudes from only one of the side surfaces of the body.

2. The combination padlock with an integrated bottle opener according to claim 1, wherein the cross-sectional thickness of the tooth tapers from the central segment of the body toward the shackle.

3. The combination padlock with an integrated bottle opener according to claim 1, wherein the tooth is embedded in one of the side surfaces of the body, and a virtual surface extending from a surface of the shackle is spaced apart from a virtual surface extending from a surface of the tooth.

4. The combination padlock with an integrated bottle opener according to claim 1, wherein the tooth is embedded in the body.

5. The combination padlock with an integrated bottle opener according to claim 1, wherein the tooth and the body are molded as a single integrated piece.

6. The combination padlock with an integrated bottle opener according to claim 1, wherein the tooth extends from one end portion of the body in a longitudinal direction to a boundary of the other end portion of the body in the longitudinal direction.

7. The combination padlock with an integrated bottle opener according to claim 1, wherein the cross-sectional thickness in a longitudinal direction of the tooth tapers from a protruded portion of the tooth at the boundary of the body toward the shackle.
